(19) United States
(12) Patent Application Publication
(10) Pub. No.: US 2008/0019596 A1
(43) Pub. Date: Jan. 24, 2008

(54) Imaging Method and Apparatus for Analysing Objects

(75) Inventors: Jens-Peter Seher, Stuttgart (DE); Johannes Bacher, Leonberg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,145

(22) PCT Filed: Sep. 12, 2005
(86) PCT No.: PCT/IB05/52971

§ 371 Date: Mar. 13, 2007

(30) Foreign Application Priority Data
Sep. 16, 2004 (EP) 04104478.5

(51) Int. Cl. G06K 9/62

(52) U.S. Cl. 382/224

(57) ABSTRACT

The invention relates to an imaging system and a method for analysing an object. A first image of the object is created with an image recording unit and used to determine the further processing required and/or the characteristics of the analysed object. Further image processing in order to obtain information from the analysed object is carried out based on the initial information obtained from the image. The system and method are used for example in analysis of medical test strips.

The invention relates to an information-collecting device and a method for collecting information.

An information-collecting device for use in a clinical laboratory environment is known from publication DE 198 57 426 A1. In this information-collecting device, test strips with color change bars used in the analysis of body fluids are fed to the device by using a transport device. The color values of the color change bars of the test strips are collected by means of a photometric arrangement. The results of the measurement are output via a printer.

A disadvantage in the described arrangement is that it is restricted to one single type of test strips. Particularly in a clinical environment, however, various test strips are used.

It is an object of the invention, therefore, to provide an information-collecting device which can be put to multiple uses.

The object is achieved by means of an information-collecting device comprising an image recording unit for creating an image of at least one information carrier present in the image area and an image processing unit designed for determining, from the image, information represented on the information carrier, in dependence on the classification information about the information carrier.

The use of classification information makes it possible here to use the most diverse information carriers. In contrast to the state of the art, the determination of the actually relevant information represented on the information carrier is effected here in dependence on the classification information. The classification information indicates the type of the information carrier and the image-processing unit can use suitable processing steps specifically adapted to the information carrier. Information carriers may be, for example, different test strips with color change bars, autonomous devices, which display a measured result as a numerical value on for example a CD display, fluorescence cartridges, bar code strips etc.

In an embodiment of the described information-collecting device, the classification information is determined from the image of the information carrier. This allows fully automatic information collection by any kind of information carriers. The information carriers are defined uniquely by the classification information. The classification information can be determined here by, for example, the external form of the information carrier or by means of a bar code placed on the information carrier.

In another embodiment of the information-collecting device, the image-recording unit is equipped to change image parameters. This pertains especially to the geometrical image parameters such as distance, relative position between image recording unit and information carrier and resolution of the image. For example after a first image, another image can be recorded with adjusted image parameters, which simplifies the determination of the information by, for example, adjusting the image section and the resolution.

In another embodiment of the information-collecting device, it has a memory unit in which auxiliary data are stored, which simplify or make at all possible the determination of information from the information carrier. Auxiliary information can be the data about the relative location at which the information carrier defined by means of its classification information shows the relevant information.

After a first image at low resolution, by means of which the image-processing unit has found more or less the shape of the information carrier and could thus determine the classification information, the area of the information carrier on which the information is represented is zoomed in on and an image is recorded at higher resolution. The area on which the information is represented is defined there by the stored auxiliary information.

Another embodiment of the information-collecting device has an input unit by means of which the classification information is fed to the information-collecting device. If the information carrier has a bar code, which indicates the type of the information carrier, then this bar code can be read-in by a bar code reader functioning as an input device and supplied to the image processing unit as classification information. An input unit may, however, also be a keyboard, by means of which the classification information can be inputted directly, or by means of a touch screen the current information can be selected from a selection of possible information carriers.

In another embodiment, the information-collecting device is linked to a database unit. Typically, the information that is determined by the information-collecting device in a medical or clinical environment is to be assigned to a patient. The information-collecting device is then equipped to assign the specific information to a record of the database unit, such as a patient database in the present example. Other users of other devices coupled to the database unit then also have access to the information through the database unit, which information then has already been assigned to the correct record.

In yet another embodiment, the information-collecting device has a transport unit that supplies the information carrier to the image-recording unit. Furthermore, the information-collecting device can have a position-manipulating unit that can change the relative position of the information carrier with respect to the image-recording unit. The position-manipulating unit can change the information carrier and/or the image-recording unit in its absolute position.

A signal transmitter is provided in an embodiment of the information-collecting device. This transmitter can give an optical or acoustic signal, for example, if the determination of the information represented on the information carrier was completed successfully, so the user knows that other information carriers can be fed to the information-collecting device. The signal transmitter can give another signal, if it is impossible for it to determine the information, for example because the information carrier is so displaced or tilted that the represented information is not recognizable.

In another embodiment, the image-recording unit of the information-collecting device is equipped to carry out automatic calibration. This concerns the color balance, the white balance, corrections to the gain factor of the individual picture elements and their offset-signal etc. For this purpose, a reference can be fed to the image-recording unit whose current image is compared to a stored reference image.

In another embodiment, the information-collecting device has an activation unit, by means of which the information carrier is brought to an active state from an inactive state in which the information is not represented. If the information carrier is a fluorescence cartridge, for example, by means of which results of investigation are represented through the fluorescence of fluorescent components, the activation unit can be a light source, such as a laser diode, which excites the fluorescence. After the activation of the information carrier, an image of the activated information carrier is then created; thus in the current case an image of the fluorescence distribution is created in the fluorescence cartridge.

The invention also relates to a method for collecting the information that is represented on an information carrier, which method comprises the following steps:
Feeding the information carrier into an image area,
Creation of an image of the information carrier,
Determination of the information represented on the information carrier in dependence on classification information.

In another embodiment, the method is characterized by the step of determining the classification information from the image. In another embodiment, the method is characterized by the step of creating a second image of the information carrier with changed image parameters and in yet another embodiment, the method comprises the step of assigning the determined information to a record in a database.

These and other aspects of the invention are apparent from and will be elucidated, by way of non-limitative example, with reference to the embodiment(s) described hereinafter.

In the drawings:

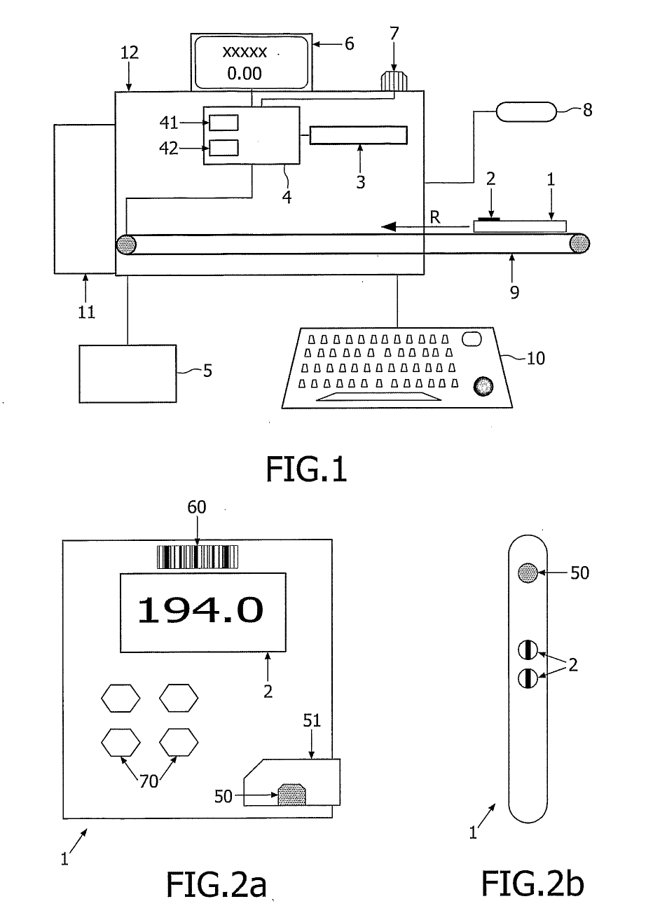

FIG. 1: gives a schematic representation of an information-collecting device according to the present invention, with an information carrier on a transport unit,

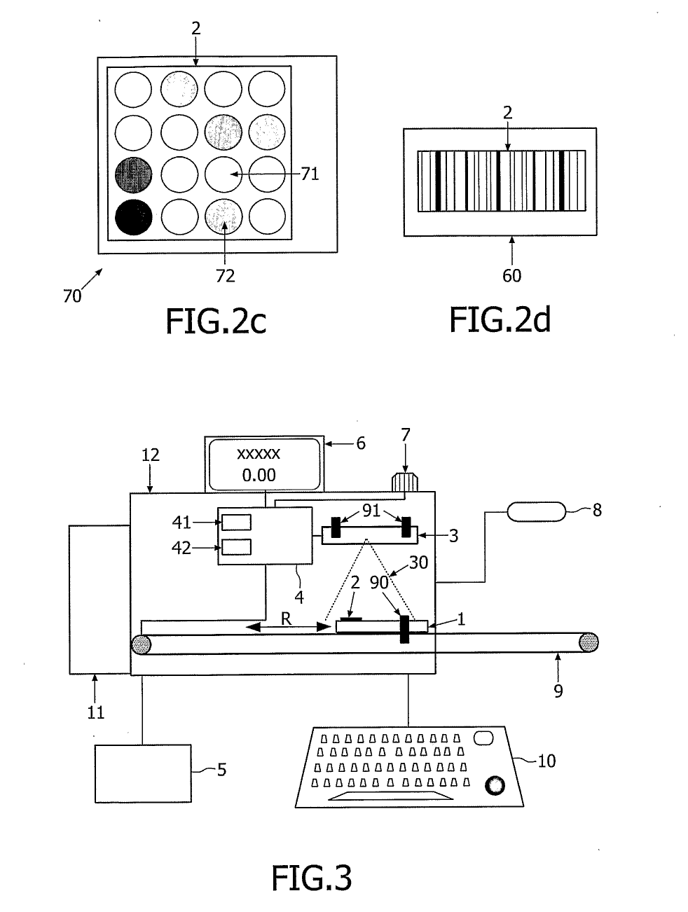

FIG. 2a: shows an exemplary information carrier with an optical indication for representing information;

FIG. 2b: shows another exemplary information carrier with a simple optical indication for representing information,

FIG. 2c: shows another exemplary information carrier, here a schematically drawn fluorescence cartridge which, in an active state, displays the information by means of fluorescence distribution,

FIG. 2d: shows another exemplary information carrier, in which the information is represented as a bar code,

FIG. 3: gives a schematic representation of an information-collecting device as in FIG. 1, but with the information carrier in the image area of the image recording unit,

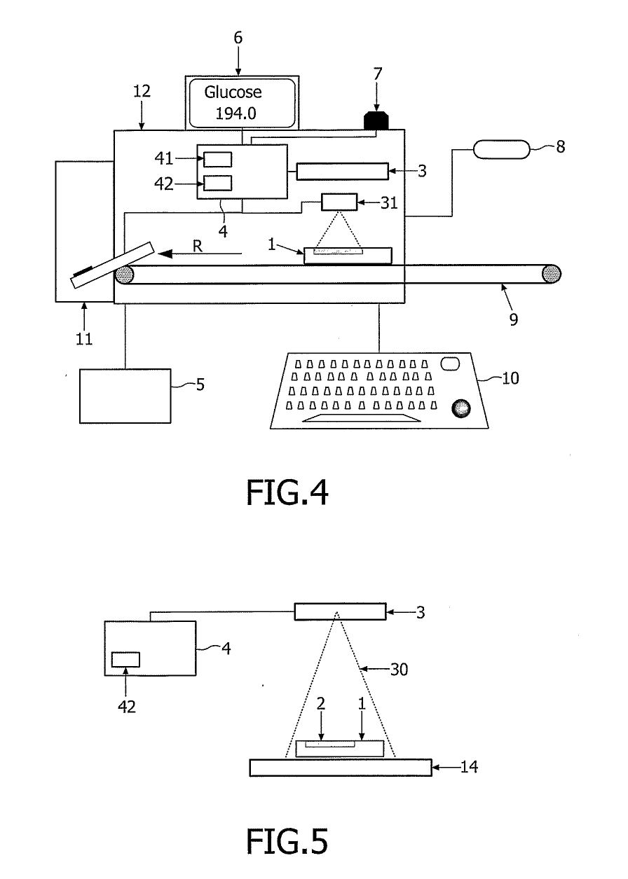

FIG. 4: gives a schematic representation of an information-collecting device as in FIG. 1, but with the information carrier in a discharging position,

FIG. 5: gives a schematic representation of a simple design of an information-collecting device and

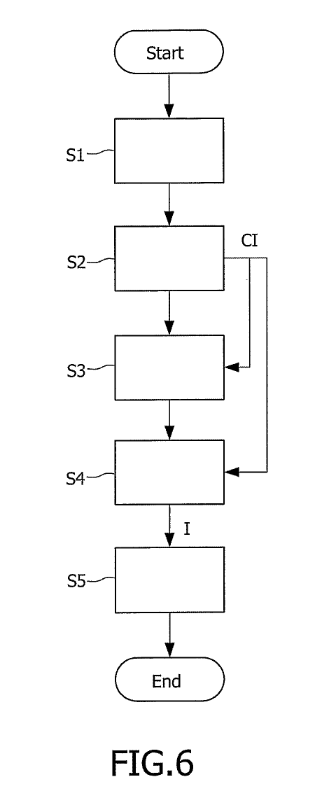

FIG. 6: shows a flow chart of an exemplary method for collecting information.

In a clinical environment, in hospitals, clinical laboratories and medical practices, measuring means are increasingly in use, by means of which measurements on body samples (blood, urine, fecal matter, cell samples etc) of a patient can be carried out. Especially measured is the presence of specific molecular components or their concentration in the body sample. If the measurement is carried out, for example, directly on the patient bed, the measurement result is available in the shortest possible time (seconds to minutes), whereas traditional laboratory investigations often require hours or even days. In particular, such measurements are carried out in an intensive care environment, where the time factor is a critical factor and quickly available measurement results lead to a distinctly better treatment.

Often the most diverse and mutually incompatible measuring means are used to obtain patient data, such as glucose measuring units or test strips with color-change bars (the best known of such strips is certainly the pregnancy test, in which the HCG hormone in the urine is proved by specifically linking to antibodies), in which automatic forwarding of the measurement results to the patient's record is not possible. The measurement results are entered manually by an assistant keying in the obtained information about the patient in a record of (the electronic patient file). This may involve many kinds of errors, due to mistyping or misplacing the information. Other information, such as medication for the patient or administration of an infusion, is often entered by using bar code strips. This again may also involve errors. Due to the need to pay urgent attention to the patient, such information is entered into the electronic patient file only later. This may lead to errors in terms of the time of medication. Or the bar code strip may simply be mislaid.

The mentioned measuring devices, test strips and bar code strips have one common factor: the relevant information, which is supposed to be fed to the record (the electronic patient file) is represented on the respective information carrier (measuring device, test strips, bar code strips) in an optically recognizable form.

The present invention solves the described problems in that it provides an information-collecting device by means of which the respective information represented on the information carrier is determined by creating a digital image of the information carrier and analysis of this image through image processing. Image processing effected here depends on classification information describing the type of information carrier. It is thus possible to use the most diverse information carriers.

The embodiments and working methods of an information-collecting device as invented is described below. Such an information-collecting device is used especially in the medical environment, i.e. in a hospital and in particular in an intensive care environment, where quick processing of measurement results is an important factor for the quality of support to the patient. Such an information-collecting device can, however, also be used in a medical practice or in a laboratory. The word laboratory is not restricted here to clinical laboratories, but also means other types of laboratories including food laboratories etc.

FIG. 1 shows schematically an information-collecting device according to an embodiment. An information carrier 1 rests on a transport unit 9, which information carrier has a display area 2, through which it can display one or more measurement results. Typical information carriers are shown in FIGS. 2a to 2d. As an example, the transport unit 9 is drawn here as a conveyor belt, which conveys the information carrier 1 in the direction of the arrow R into the casing 12 of the information-collecting device. Instead of a conveyor belt, the transport unit can also be designed as a movable plate on rails, such as a robotic arm etc. The transport unit can also be designed such that the information carrier can be moved by it in all spatial directions and around all spatial axes. An image-recording unit 3 is arranged within a casing 12. The image-recording unit 3 is linked to an image-processing unit 4. The image-processing unit 4 has a processing unit 41 and a memory unit 42. Furthermore, the image-processing unit 4 is connected to a signal transmitter 7, a display unit 6, an input unit 10, a further input unit 8, which can be, for example, a scanner and a database unit 5. In this embodiment, the image-processing unit 4 is also control unit for the information-collecting device. The input units 10 or 8 are used for input or supply of data, for example control data (for example: start of the information determination process or an emergency off-command) and assignment data (for example: Patient data or information about the currently supplied information carriers). Patient data may be entered, for example, through the input unit 10, a keyboard, by means of which the record assigned to the patient is selected from the linked database unit 5 and more information can be supplied to this record. Instead of keying in the patient record, patient data can also be entered via the input unit 8, for example a bar code scanner, by scanning a unique bar code, which is placed on, for example, the patient's bed and the assigned record can then retrieved from the database unit 5. Instead of being in the form of a bar code, the patient information can also be available, for example, in the form of a high-frequency identification wristband (HF-ID-band) worn by the patient and the input unit 8 can be configured as a HF receiving device. In the embodiment shown there is a removable disposal unit 11, mechanically docked to the casing 12, which is used to ensure that information carriers 1, which are used only once—such as test strips—and are contaminated with a patient's blood, can be disposed of easily and without any further interaction from the user.

A user who wishes to add information about a patient shown on an information carrier 1 to the electronic patient file, places the information carrier 1 on the transport unit 9. With the input unit 8, the user scans a bar code strip placed on the patient's bed. By using this unique patient information, the information-collecting device can access the electronic patient file in the database unit 5 or download, for example, parts from the electronic patient file if required. In the clinical environment, the database unit 5 is particularly a hospital information system (HIS). The information determination process of the information-collecting device is started by pressing a start button on the input unit 10 and the information displayed on the display area 2 of the information carrier 1 is determined, as described in context with FIG. 3 and FIG. 4.

FIG. 2a shows an example of an information carrier 1, which is configured here as a glucose measuring device. Such an information carrier 1 can be used several times. On the measuring strip 51, there is a measuring field 50, which is here a sensor for measuring the blood sugar content. The measuring strip 51 can be slid into the information carrier 1 configured as glucose measuring device and the measuring field 50 is contacted electrically through contacts. The measurement result is displayed on the optically readable display panel 2. The information is thus represented in the form of numbers on an LCD screen. The information carrier 1 can have operating element 70, by means of which a measurement can be started or the information carrier 1 can be switched off again. In the embodiment shown here the information carrier 1 also has a bar code 60. Such a bar code 60 can uniquely characterize the information carrier 1. Before the information carrier 1 is placed on the transport unit 9 of the information-collecting device, a user can read-in the bar code 60 of the information carrier 1 by means of an input unit 8, which is configured as a scanner. The input unit 8 supplies the result to the image processing unit 4, where a unique assignment of the just supplied information carrier 1 to other tabulated values can be effected, for example, by means of the tables of bar code strips stored in the memory unit 42. The image-processing unit 4 thus determines the classification information from the supplied bar code information, which is a glucose-measuring device here, in the case of the information carrier 1. Depending on the classification information, corresponding programs are then activated in the processor unit 41, which are particularly suited for the extraction of measurement results of a glucose-measuring device of the particular type. Instead of scanning-in the bar code, this bar code can also be determined from an image of the information carrier. As described further down, the image-processing unit 4 recognizes that a bar code 60 is placed on the supplied information carrier 1 and the bar code information is determined, whereby also the classification information is determined.

FIG. 2b shows an example of another information carrier 1, which is a type of pregnancy test here. The pregnancy test has a measuring field 50 and, in this embodiment, a display area 2 consisting of two windows. Such an information carrier is typically a single-use carrier and can be disposed of automatically in the disposal unit 11 in the information-collecting device as shown in FIG. 1 (in this context reference is also made to FIG. 4).

FIG. 2c shows schematically an information carrier configured as a fluorescence cartridge 70. There are various measuring fields 70, 71 in the cartridge, each of which contains a specific linking molecule, to which various proteins provided with fluorescing markings can be coupled. After excitation of the fluorescence, the distribution of the fluorescence intensities in the various measuring fields 71, 72 provides an assessment of the type and concentration of the proteins in the sample fluid. FIG. 2c shows schematically the fluorescence distribution and intensity by means of non-fluorescing measuring fields 71 and fluorescing measuring fields 72. The measuring fields form the display area 2 of the fluorescence cartridge.

FIG. 2d shows another example of an information carrier, which is configured here as a bar code strip. Paper-strips with bar code information are used on medications or infusions administered to a patient. The paper-strip is torn off from the infusion bottle and can be supplied to the information-collecting device. In case of a bar code strip, the area on which the actual bar code is printed is the display area 2.

The working method of the information-collecting device is now explained in greater detail with the help of FIGS. 3 and 4.

FIG. 3 differs from FIG. 1 mainly in that the information carrier 1 has been moved by transport unit 9 to a position inside the casing 12. In FIG. 1, the information carrier 1 was placed by a user on the transport unit 9 and the start of the data processing routine was initiated by the user, for example, by means of the input unit 10, which is configured here as a keyboard with additional operating elements such as a trackball and an emergency off switch. The image-recording unit 3 then records an image of the external information carrier 1. The image recording unit 3 is triggered here by weight sensors (not shown) below the transport unit 9, which is configured here as a conveyor belt. In another embodiment, photoelectric guards (not shown) could indicate the correct position of the information carrier 1. The photo-electric guards (or the weight detectors) are coupled to the image processing unit 4, where the image processing unit 4 then stops further conveyance of the information carrier 1 by means of the transport unit 9 and triggers the image recording unit 3. The image area 30 is shown by the triangular area drawn in a dotted line. Instead of photoelectric guards or weight detectors, the correct positioning of the supplied information carrier can also be recognized by continuously creating an image. Each image is fed to the image-processing unit 4, which checks if there is any information carrier on the transport unit. If an information carrier moves into the image area, then the positioning is controlled by means of the image-processing unit 4.

The image-recording unit 3 generates a digital image of the information carrier 1 and supplies the digital image data to the image-processing unit 4. The image recording unit 3 can then be configured as a digital camera, in which a two-dimensionally resolved image is generated by using a single recording, or the image recording unit 3 can be configured as scanner, in which a two-dimensionally resolved image is generated by two-dimensional scanning with a single image sensor or a single-dimensional scanning by a row of image sensors.

If the external image unit has no bar code strip by means of which it can be uniquely assigned, then the type of the external information carrier 1, which has currently been recorded, is determined in the image-processing unit 4 with the help of the digital image. This can be done, for example, by comparing the current image in the processing unit 41 with reference recordings from various information carriers stored in the memory unit 42. For the comparison with reference recordings, a tilted position of the currently recorded external information carrier can be determined as reference recording by optimizing the comparison parameter. The type of information carrier is defined by classification information. If the type of the current information carrier and its position has been determined, then tabulated values, which are stored in the memory unit 42 and which can be accessed via the classification information, define where the display area 2 of the information carrier 1 can be found. Since the position and the alignment have been defined previously by comparison with reference recordings of information carriers, the absolute position of the display area can be calculated with the help of tabulated relative position values in the current image. An evaluation program defined by the classification information can now be loaded into the processor unit 41 and the image area corresponding to the display area 2 of the information carrier 1 is analyzed and the information represented in the display area is defined. The evaluation program for a glucose-measuring device as shown in FIG. 2a is specially adapted to suit the recognition of the numbers on an LCD display. This recognition can be effected, for example, by comparing reference recordings of numbers displayed on the display area 2 of such an external information carrier l with the current recordings. If it is an information carrier 1 as shown in FIG. 2b, then it only needs to be checked whether a prominent strip can be recognized in the display area 2. In other test strips, the color of a color change bar may have to be determined to extract the represented information.

Instead of carrying out the analysis of the information represented in the display area 2 of the information carrier 1 on the already recorded image, the image-processing unit 4 can activate the image-recording unit 3 in such a way that another image is recorded only from the display area 2. If a bar code is mapped in the display area, only then is it possible to analyze, if need be, the fine bar code lines by using a further enlarged image with higher resolution. For this purpose, the image recording unit 3 is equipped to change the image parameters, for example by means of controllable optics so that the display area can be zoomed in. If a CCD camera is used as the image recording unit 3, the individual pixels can either be combined or read out individually, so that an image is recorded with lower or higher resolution. For faster processing, for example when checking whether an information carrier 1 moves into the image area 30 at all, an image parameter mode with low resolution and a large image field can be selected.

Furthermore, FIG. 3 shows a position-manipulating unit 90, which can act on the information carrier 1 to change the position of the carrier relative to the image-recording unit 3. The position manipulating unit 90 may then be part of the transport unit, for example a holder in which the information carrier 1 is embedded, or it may be an independent unit that seizes the information carrier 1 inside the casing like a robotic pick-up arm. The image processing unit 4, which determines from the image analysis the position of the current information carrier 1 in comparison with the position of an information carrier in a reference recording (reference position), then acts on the position manipulating unit 90 in such a way that the information carrier 1 is brought into the reference position, which facilitates extraction of the represented information, because displacements and tilts need not be considered in the image analysis. For this purpose, the image-processing unit 4 activates the image-recording unit 3 in such a way that another image is recorded if the information carrier 1 is in the reference position. In order to reach the reference position or to achieve a better positioning of the external information carrier 1 in the image area 30, the image processing unit 4 can also activate the transport unit 9, so that the information carrier 1 is moved ahead or back in the direction of the double arrow R. Alternatively or additionally, the image recording unit 3 can also be provided with a position-manipulating unit 91. The position-manipulating unit 91 can then tilt, move, twist the image-recording unit 3 relative to the information carrier 1 or move the image-recording unit 3 around the information carrier 1 in an arc.

FIG. 4 shows the information-collecting device at a later time. The signaling unit 7, designed here as an optical signal transmitter, has switched on (indicated by blackening of the signaling unit 7), to indicate to the user that information has been successfully extracted from the image of the current information carrier 1. Instead of an optical signal transmitter 7, also an acoustic signal transmitter can be used. In this embodiment, the information—in the example shown this is the information of the blood sugar level value of the patient—is displayed on the display unit 6 (“194.0”) and there is also displayed which type of information carrier 1 was recognized (denoted by the displayed word: “Glucose”). The user can then confirm the result by means of the input unit 10, upon which the extracted measurement result is stored in the memory unit 42 or supplied to the database unit 5 (where it is recorded in the electronic patient file). Depending on the type of information carrier 1, it is driven out of the information-collecting device again by means of the transport unit 9 for repeated use, or the information carrier 1 is moved to the disposal unit 11 to be disposed of. FIG. 4 shows how a non-reusable information carrier (such as a test strip), is moved to the disposal unit 11. The signal transmitter 7 can also be used to show if extraction of a measurement result is not possible, which happens, for example, if the information carrier was placed on the transport unit with the display area facing downwards. The user can then effect the transport once again or correct the position manually.

Furthermore, FIG. 4 shows another information carrier 1, which is a fluorescence cartridge. The fluorescence cartridge was recognized as such and an activation unit 31 was moved over the fluorescence cartridge, on the basis of the classification information. In this example, the activation unit 31 is a light source, which excites the fluorescence of the fluorescent marker in the measuring fields of the fluorescence cartridge. Once the fluorescence has been excited, the activation unit 31 is again driven to one side and the image-recording unit 3 carries out a long-duration recording of the display area of the fluorescence cartridge, which may last quite a few minutes. Light sources, which are used for the normal recordings of information carriers, are switched off then.

If, for example, a CCD camera is used as the core of the image recording unit 3, the image recording unit can be arranged to carry out automatic calibration in which the white balance, color balance, the gain factor and/or the offset value are carried out for the CCD camera or for each individual picture element of the CCD camera. Also a reference object may be recorded for calibration purposes, whose current recording is then compared with a stored reference recording, so that factory settings can be restored after the calibration.

FIG. 5 shows a design for a simple embodiment of an information-collecting device as invented. It comprises an image recording unit 3, an image-processing unit 4 and a storage space 15 for an information carrier 1. After the information carrier 1 has been placed in the storage space 15, the image-recording unit 3 is activated, either automatically or manually, for recording an image from the information carrier 1. The generated image is then analyzed in the processor unit 41; the classification information is determined and the information shown on the display area 2 of the information carrier is extracted from the recorded image or some other image. When analyzing the digital image in the processor unit, a position correction can be made, so that the corrected image of the information carrier corresponds to a reference position, which simplifies further analysis. A position correction is advisable especially if the information-collecting device, in a simple embodiment, has no scope for the mechanical change in the position of the information carrier.

FIG. 6 shows, by way of example, with the help of a flow chart, the flow of the method for collecting information. The described method relates to an information-collecting device as shown in FIG. 5. First, the method is started. For this purpose, an information carrier 1 is placed in the storage space 15, so that the display area 2 of the information carrier 1 lies in the image area 30. A digital image is then recorded by the image-recording unit 3 in step S1 of the method. This image is subjected to an analysis through image processing algorithms in step S2. The image processing algorithms run in the image-processing unit 4. The classification information CI is determined from the shape of the information carrier, which is determined, for example, from the detection of edges or by recognition of a bar code strip placed on the information carrier. One or more images are then recorded on the basis of the classification information CI as step S3, for example, by zooming in on the information carrier display area 2 known from the classification information CI. The new image is then subjected to an analysis in step S4, where the represented information is extracted. Special algorithms are then downloaded from the memory 42 in dependence on the classification information CI and used for image analysis. In step S5, the extracted information I is then supplied to a record in a database. The method is then terminated. In other methods, which would be run, for example, with a device as shown in FIG. 1, even more method steps as described above could be added.

1. An information-collecting device comprising
an image recording unit (3) for creating an image of at least one information carrier (1) situated in an image area (30) and
an image processing unit (4), which is arranged for determining information represented on the information carrier (1) from the image on the basis of classification information about the information carrier (1).

2. A device as claimed in claim 1, characterized in that the image-processing unit (4) determines the classification information from the image of the information carrier (1).

3. A device as claimed in claim 1, characterized in that the image-recording unit (3) is arranged for changing image parameters,

4. A device as claimed in claim 1, characterized in that the image processing unit (4) has a memory unit (42), in which auxiliary data for determining the information represented on the information carrier (1) are stored.

5. A device as claimed in claim 1, characterized in that the device has an input unit (8, 10) linked to the image-processing unit (4) for inputting the classification information.

6. A device as claimed in claim 1, characterized in that the device is linked to a database unit (5) and is arranged for assigning the information to a certain record of the database unit (5).

7. A device as claimed in claim 1 characterized in that the device has a transport unit (9) for transporting the information carrier (1) to the image-recording unit (3).

8. A device as claimed in claim 1, characterized in that the device has a position-manipulating unit (90, 91) for manipulating the position of the information carrier (1) relative to the image-recording unit (3).

9. A device as claimed in claim 1, characterized in that the device has a signaling unit (7) linked to the image-processing unit (4).

10. A device as claimed in claim 1, characterized in that the image-recording unit (3) is arranged for carrying out automatic calibration.

11. A device as claimed in claim 1 characterized in that it has an activation unit (31), which is arranged for displacing the information carrier (1) from an inactive state, in which the information is not represented, to an active state.

12. A method for collecting information represented on an information carrier (1), which has the following steps:
feeding the information carrier (1) into an image area (30),
creation of an image of the information carrier (1),
determining the information (I) represented on the information carrier (1) on the basis of the classification information (CI).

13. A method as claimed in claim 12, characterized in that the other steps are: determining classification information (CI) from the image.

14. A method as claimed in claim 12, characterized in that it contains the following further step:
creation of a second image of the information carrier (1) with changed image parameters.

15. A method as claimed in claim 12, characterized in that it contains the following other step:
assigning the information (I) to a certain record in a database.
